(19) United States
(12) Patent Application Publication
(10) Pub. No.: US 2023/0174830 A1
(43) Pub. Date: Jun. 8, 2023

(54) ELECTRICALLY PEELABLE ADHESIVE COMPOSITIONS FOR HIGH TEMPERATURE EXPOSURE

(71) Applicant: NITTO DENKO CORPORATION, Ibaraki-shi, Osaka (JP)

(72) Inventors: Eduardo AGUIRRE, Oceanside, CA (US); Yufen HU, San Diego, CA (US); Stanislaw RACHWAL, Oceanside, CA (US); Peng WANG, San Diego, CA (US)

(21) Appl. No.: 17/916,297

(22) PCT Filed: Mar. 30, 2021
(86) PCT No.: PCT/US2021/024884

§ 371 Date: Sep. 30, 2022

Related U.S. Application Data
(60) Provisional application No. 63/002,308, filed on Mar. 30, 2020.

(51) Int. Cl. C09J 9/02; C09J 133/14; C08F 220/28

(52) U.S. Cl. CPC C09J 9/02; C08F 220/281; C09J 133/14; C08K 5/3445; C09J 2203/326; C09J 2301/502; C09J 2433/00

(57) ABSTRACT

An electrically peelable adhesive composition including: an acrylic polymer, in which the acrylic polymer is a product of reacting a mixture including a polar monomer including a hydroxyl group and a polar monomer including an alkoxy group; an ionic liquid including a cation, a first anion and a second anion, in which the first anion is an alkyl sulfonate and the second anion is a sulfonylimide; and a vinyl compound including nitrogen.

### CROSS-REFERENCE TO RELATED APPLICATIONS

This application claims the benefit of U.S. Provisional Application No. 63/002,308, filed Mar. 30, 2020, which is incorporated by reference herein in its entirety.

### FIELD

This disclosure relates to compositions and/or materials for use as coatings and adhesives in high temperature applications, that may be disbanded from a surface to which they are applied, without harm to that surface, upon the application of electromotive force. This disclosure relates to cationic imidazolium and anionic sulfonylimide compositions and additives thereto.

### BACKGROUND

In semiconductor production, there is a need for securing and removing a device wafer to a metal carrier for processing. Typically, pressure sensitive adhesives are widely incorporated for securing and removing of the device wafers during processing. However, these pressure sensitive adhesives, during the device wafer removal process from the metalized carrier, leave an adhesive residue on the metal carriers, requiring an expensive and time-consuming cleaning process. As the demand for higher performance semiconductor chips increase, device wafers are becoming larger (up to 300 mm) and thinner, (down to 30 microns), leading to handling problems during the processing procedure. In such applications, there is a demand for providing an adhesive having both high adhesion, along with ease of peeling (peelability) when removing the wafer from the metal carrier.

An ionic liquid may be incorporated in applications for adhesion and clean peelablility. The ionic liquid includes cations and anions, and has properties such a nonvolatility, incombustibility, and chemical stability. The peeling is performed by applying a voltage, which initiates electrolysis of the ionic liquid, thereby weakening the adhesive interface. However, during wafer processing, heat is generated, upwards of over 220° C., which results in a breakdown of the adhesive polymer, which in turn results in loss of adhesiveness.

Thus, there is a need for a temporary adhesive that may withstand the high temperature generated during wafer processing and be separated from a metal surface, without damaging the device wafers, or leaving adhesive residue on the metal carrier post separation.

### SUMMARY

The present disclosure describes an electrically peelable adhesive composition having reduced corrosiveness upon removal.

Some embodiments include an electrically peelable adhesive composition comprising: an acrylic polymer, wherein the acrylic polymer is a product of reacting a mixture comprising a polar monomer comprising a hydroxyl group and a polar monomer comprising an alkoxy group; an ionic liquid comprising a cation, a first anion and a second anion, wherein the first anion is an alkyl sulfonate and the second anion is a sulfonylimide; and a vinyl compound comprising nitrogen.

In some embodiments, the electrically peelable adhesive composition comprises an acrylic polymer, wherein the acrylic polymer comprises a polar monomer comprising a hydroxyl group, and a polar monomer comprising an alkoxy group. Some examples include ionic liquids, wherein the ionic liquids comprise a cation. In some cases, the cation is a 1-ethyl-3-methylimidazolium cation. In other embodiments, the ionic liquids comprise a first anion and a second anion, wherein the first anion is an alkyl sulfonate and the second anion is a sulfonylimide. In some embodiments, the electrically peelable adhesive composition comprises a vinyl compound comprising nitrogen. In some examples, the vinyl compound comprising nitrogen is vinyl imidazole. In some embodiments, the acrylic polymer of the electrically peelable adhesive composition comprises 2-methoxyethyl acrylate. In some embodiments, the acrylic polymer of the electrically peelable adhesive composition comprises 4-hydroxybutyl acrylate. In some embodiments, the acrylic polymer of the electrically peelable adhesive composition is crosslinked with a diisocyanate crosslinker. In some examples, the diisocyanate crosslinker is xylene diisocyanate.

Other embodiments of the present disclosure include a method for making an electrically peelable adhesive composition. In some embodiments, the method includes: preparing a mixture of an acrylic polymer comprising a hydroxy containing monomer and an alkoxy containing monomer; mixing the acrylic polymer with ionic liquids, wherein the ionic liquids comprise a cation and one or more anions, wherein at least one anion comprises an alkyl sulfonate; adding a vinyl compound comprising nitrogen; and crosslinking the mixture with a diisocyanate crosslinking agent.

### BRIEF DESCRIPTION OF THE DRAWINGS

FIG. 1 is a side view of an embodiment of a construct for the fabrication of a device wafer as described herein.

FIG. 2 is a schematic of a device incorporating an embodiment of an ionic debondable adhesive as described herein.

FIG. 3 is a schematic of a device used in testing the adhesion quality of the embodiments of ionic liquid composition found herein.

FIG. 4 is a peeling strength vs. time plot of various comparative embodiments and an embodiment of a compound described herein being tested in the device shown in FIG. 3 at ambient temperature (about 25° C.).

FIG. 5 is a peeling strength vs. time plot of various comparative embodiments and an embodiment of a compound described herein being tested in the device shown in FIG. 3 at ambient and 220° C. temperature.

### DETAILED DESCRIPTION

The present disclosure includes electrically peelable adhesive compositions having high adhesion and thermal stability, which may be easily peeled off by the application of an electrical potential for a short time.

As used herein, “temporary adhering” or “temporarily adhering” refers to an adhesive that experiences a loss of adhesiveness under specific conditions, for example, the application of an electromotive force, such as about 1 to 50 volts of DC electricity.

As used herein, the term “metalized” refers to a surface that has a conductive metal surface attached thereto. The metal surface may be attached permanently or temporarily. Any metal which is suitable for conducting an electrical charge may be used.

As used herein, “optionally substituted” group refers to a group that may be substituted or unsubstituted. A substituted group is derived from the unsubstituted parent structure wherein one or more hydrogen atoms on the parent structure have been independently replaced by one or more substituent groups. A substituted group may have one or more substituent groups on the parent group structure. The substituent groups are independently selected from optionally substituted alkyl, -O-alkyl (e.g.—OCH₃, —OC₂H₅, —OC₃H₇, —OC₄H₉, etc.), —S—alkyl (e.g. —SCH₃, —SC₂H₅, —SC₃H₇, —SC₄H₉, etc.), —NR′R″, —OH, —SH, —CN, —NO₂, or a halogen, wherein R′ and R″ are independently H or optionally substituted alkyl. Wherever a substituent is described as “optionally substituted,” that substituent may be substituted with the above substituents.

The term imidazolium refers to the ring system below:

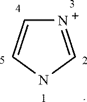

The term bis(fluorosulfonyl)imide refers to the chemical structure shown below:

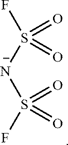

The term bis(trifluoromethanesulfonyl)imide [(F₃C)SO₂)₂N]⁻refers to the chemical structure shown below:

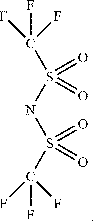

As used herein, the term “very hygroscopic” refers to a material that very rapidly adsorbs moisture/water from the environment.

The use of the term “may” or “may be” should be construed as shorthand for “is” or “is not” or, alternatively, “does” or “does not” or “will” or “will not,” etc. For example, the statement “an electrically peelable adhesive composition may include an acrylic polymer” should be interpreted as, for example, “In some embodiments, an electrically peelable adhesive composition adhesive comprises an acrylic polymer,” or “In some embodiments, a an electrically peelable adhesive composition adhesive does not comprise an acrylic polymer.”

Some embodiments of the current disclosure comprise an electrically peelable adhesive composition, which may include an acrylic polymer; an ionic liquid, and at least one polymer modifier. In some embodiments, at least one ionic liquid or additive may be very hygroscopic.

Some embodiments include an electrically peelable adhesive composition comprising an acrylic polymer, wherein the acrylic polymer comprises at least one polar monomer group comprising a hydroxyl group and at least one polar monomer comprising an alkoxy group.

In some embodiments, the electrically peelable adhesive composition may comprise an ionic liquid obtained by mixing two or more different precursor ionic liquids, to result in an ionic liquid comprising at least one cation and two or more anions, and wherein the ionic liquid is greater than 11.0 wt% by mass of the polymer. In some embodiments, the ionic liquids is about 10-25 wt%, about 10-15 wt%, about 15-20 wt%, about 20-25 wt%, about 15.5 wt%, about 20%, or any value in a range bounded by any of these values, of the total mass of the polymer.

In some embodiments, at least one of the precursor ionic liquids mixed to form the ionic liquid of the electrically peelable adhesive composition has a low equilibrium relative humidity (ERH). Preferably the ERH of a precursor ionic liquid may be less than about 50%, less than about 40%, less than about 30%, less than about 20%, or less than about 15%, at room temperature (about 20° C.). In some embodiments, the ERH is low enough to render the at least one ionic liquid very hygroscopic.

In some embodiments, the composition may contain a cation, such as an imidazolium, e.g. 1-ethyl-3-methyl imidazolium, in an amount that is about 0.1-10%, about 0.1-3%, about 3-7%, about 7-10%, about 4-6%, about 0.1-1%, about 1-2%, about 2-3%, about 3-4%, about 4-5%, about 5-6%, about 6-7%, about 7-8%, about 8-9%, about 9-10%, or about 5.3% of the weight of the electrically peelable adhesive composition.

In some embodiments, the composition may comprise the alkyl sulfonate anion, e.g., methane sulfonate, in an amount of about 0.1 to 5.0 wt%, about 0.1-0.5 wt%, about 0.5-1 wt%, about 1-2 wt%, about 2-3 wt%, about 3-4 wt%, about 4-5 wt%, or about 2.0 wt%, or any value in a range bounded by any of these values.

In some embodiments, the composition may comprise the sulflonylimide anion, e.g., bis(trifluoromethanesulfonyl)imide, in an amount of about 1 wt% to about 30 wt%, e.g., about 5-10 wt%, about 7-9 wt%, about 10-12 wt%, about 12-14 wt, about 14-16 wt%, about 16-18 wt%, about 18-20 wt%, about 20-22 wt%, about 22-24 wt%, about 24-26 wt%, about 26-28 wt%, about 28-30 wt%, about 10-15 wt%, about 15-20 wt%, about 20-25 wt%, about 25-30 wt%, or about 20 wt%, about 15 wt%, or any value in a range bounded by any of these values.

In some embodiments, the composition may comprise the vinyl monomer comprising nitrogen, e.g., vinyl imidazole, in an amount of about 0.1 to 10 wt% about 0.1-0.5 wt%, about 0.5-1 wt%, about 1-2 wt%, about 2-3 wt%, about 3-4 wt%, about 4-5 wt%, about 5-6 wt%, about 6-7 wt%, about 7-8 wt%, about 8-9 wt%, about 9-10 wt%, or any value in a range bounded by any of these values.

In some embodiments, the acrylic polymer may comprise a hydroxyl group containing monomer. In some embodiments, the acrylic polymer may comprise 4-hydroxybutylacrylate. In some embodiments the acrylic polymer may comprise about 1 wt% to about 40.0 wt%, about 1-5 wt%, about 5-10 wt%, about 10-20 wt%, about 20-30 wt%, about 30-40 wt%, or any value in a range bounded by any of these values, of the hydroxyl group containing monomer.

In some embodiments, the acrylic polymer may comprise an alkoxy group containing monomer. In some embodiments, the acrylic polymer may comprise 2-methoxyethyl acrylate. In some embodiments the acrylic polymer may comprise about 60 wt% to about 99 wt%, about 60-65 wt%, about 65-70 wt%, about 70-75 wt%, about 75-80 wt%, about 80-85 wt%, about 85-90 wt%, about 90-95 wt%, about 95-99 wt%, or any value in a range bounded by any of these values, of the alkoxy group containing monomer.

In some embodiments, an electrically peelable adhesive composition may comprise an acrylic polymer comprising at least one polar copolymer unit comprising a hydroxyl group. Some embodiments include at least one polar copolymer unit comprising an alkoxy group and a pendant vinyl unit. In some embodiments, the pendant vinyl groups comprise a nitrogen-containing group, such as an imidazole moiety. In some embodiments the composition may comprise an ionic liquid, wherein the ionic liquids comprise a cation, an alkyl sulfonate anion, and a sulfonylimide anion. In some embodiments, the alkyl sulfonate anion may comprise methane sulfonate. In some embodiments, the sulfonylimide anion may comprise bis(fluorosulfonyl)imide. In other embodiments, the sulfonylimide anion may comprise bis(trifluoromethanesulfonyl)imide. In some embodiments, the pendant vinyl group may comprise vinyl imidazole. In some embodiments, the acrylic polymer may be cross-linked with a cyano crosslinker comprising, e.g., an isocyanate.

Some embodiments include a method for making an electrically peelable adhesive composition. In some embodiments, the method may comprise providing an acrylic polymer comprising a hydroxy containing monomer and an alkoxy containing monomer. In some embodiments, the method may comprise mixing the polymer solution with 0.01 wt% to 10.0 wt% ionic cation and anion mixture, wherein the anion comprises an alkyl sulfonate and a nitrogen-containing vinyl composition. In some embodiments, the method may comprise crosslinking the acrylic polymer with a cyano-containing crosslinking agent. In some embodiments, the acrylic polymer may comprise 1 wt% to 40 wt% hydroxy monomer. In some embodiments, the acrylic polymer may comprise 60 wt% to 99 wt% alkoxy monomer. In some embodiments, the alkyl sulfonate anion may comprise a methane sulfonate anion. In some embodiments, the nitrogen containing vinyl composition may comprise vinyl imidazole.

### Acrylic Polymer

Some embodiments include an acrylic polymer. In some embodiments, the acrylic polymer is a common organic polymer. In some embodiments, the acrylic polymer includes a polymerized product or a partially polymerized product of monomers. In some examples, the monomer may be one particular monomer, or a mixture of two or more monomers. The term “partially polymerized product,” as used herein, means a polymerized product in which one or more components of the monomer or monomer mixture are partially polymerized.

In some embodiments, the acrylic polymer may include alkyl (meth)acrylates, alkoxyalkyl (meth)acrylates, or hydroxyl group-containing alkyl (meth)acrylates, having linear or branched-chain alkyl groups.

Examples of alkyl (meth)acrylates monomers having linear or branched-chain alkyl groups include, but are not limited to, alkyl (meth)acrylates wherein the alkyl group has 1 to 20 carbon atoms, such as methyl (meth)acrylate, ethyl (meth)acrylate, propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. The alkyl (meth)acrylates, may be used alone, or in any combination. In some embodiments, alkyl (meth)acrylates having an alkyl group of 1 to 14 carbon atoms are of particular interest. In other embodiments, alkyl (meth)acrylates having an alkyl group with 1 to 10 carbon atoms are of particular interest.

Examples of (meth)acrylic alkoxyalkyl esters (alkoxyalkyl (meth)acrylate) monomers include, but are not limited to, 2-methoxyethyl (meth)acrylate, 2-ethoxyethyl (meth)acrylate, methoxytriethylene glycol (meth)acrylate, 3-methoxy-propyl (meth)acrylate, 3-ethoxypropyl (meth)acrylate, 4-methoxybutyl (meth)acrylate, and 4-ethoxybutyl (meth)acrylate. In some embodiments, 2-methoxyethyl acrylate (2MEA) is of particular interest. In some embodiments, alkoxyalkyl (meth)acrylates may be used alone or in any combination with other acrylates.

Examples of hydroxyl group-containing alkyl (meth)acrylate monomers include 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate,12-hydroxylauryl (meth)acrylate, (4-hydroxymethyl cyclohexyl) methylacrylate, N-methylol (meth)acrylamide, vinyl alcohol, allyl alcohol, 2-hydroxyethyl vinyl ether, 4-hydroxybutyl vinyl ether, and diethyleneglycol monovinyl ether. In some embodiments, 2-hydroxyethyl (meth)acrylate is of particular interest. In order to form the acrylic polymer in the adhesive layer, one hydroxyl group-containing monomer, two hydroxyl group-containing monomers, or a combination of more than two hydroxyl group-containing monomers may be used.

In some embodiments, the acrylic polymer may comprise the acrylic monomer(s) in a content of 70 percent by weight or more, e.g., 70 to 100 wt%, 80 to 100 wt%, 90 to 100 wt%, 90 wt%, 91 wt%, 92 wt%, 93 wt%, 94 wt%, 95 wt%, 96 wt%, 97 wt%, 98 wt%, or 99 wt%, based on the total amount of monomer components for the formation of the acrylic polymer.

In some embodiments, the acrylic polymer may contain pendant nitrogen-containing monomers. Examples of nitrogen containing monomers include acrylamide, methacrylamide, N-vinyl pyrrolidone, N,N-dimethylacrylamide, N,N-dimethyl methacrylamide, N,N-diethylacrylamide, N,N-diethyl methacrylamide, N,N′-methylenebisacrylamide, N,N-dimethylaminopropyl acrylamide, N,N-dimethylaminopropyl methacrylamide, methylvinylpyrrolidone, vinylpyridine, vinylpiperidone, vinylpyrimidine, vinylpiperazine, vinylpyrazine, vinylpyrrole, vinyl imidazole, vinyloxazole, vinylmorpholine, N-vinylcarboxylic acid amides, N-vinylcaprolactam, and diacetone acrylamide. The nitrogen-containing monomer may be used alone or in any combination.

In some examples, monomer components for the formation of the acrylic polymer serving as the base polymer may further contain a copolymerizable monomer component, such as polar-group containing monomers, in addition to the acrylic monomers described above. In some embodiments, polar group-containing monomers include, but are not limited to, acrylic acid (AA), methacrylic acid (MAA), 2-methoxyethyl acrylate (2MEA), 2-hydroxyethyl acrylate (2HEA), 4-hydroxybutyl acrylate (4HBA) and 6-hydroxyhexyl acrylate (HHA), are of particular interest.

In some embodiments, the acrylic polymer is a product of reacting a mixture of acrylic monomers that contains about 0.1-100%, about 0.1-5%, about 5-10%, about 10-20%, about 20-30%, about 30-40%, about 40-50%, about 50-60%, about 60-70%, about 70-80%, about 80-90%, about 90-100%, or about 95% of 2-methoxy ethyl acrylate by weight.

In some embodiments, the acrylic polymer is a product of reacting a mixture of acrylic monomers that contains about 0.1-100%, about 0.1-5%, about 5-10%, about 10-20%, about 20-30%, about 30-40%, about 40-50%, about 50-60%, about 60-70%, about 70-80%, about 80-90%, about 90-100%, about 5%, or about 95% 4-hydroxybutyl acrylate by weight.

In some embodiments, the acrylic polymer has a molecular weight, apparent molecular weight, or an average molecular weight of about 500,000-1,500,000 g/mol, about 600,000-1,000,000 g/mol, about 700,000-900,000 g/mol, or about 800,000 g/mol.

In some embodiments, the acrylic polymer is formed by a radical polymerization. For example, a radical initiator, such as azobisisobutyronitrile (AIBN) may be included in the reaction mixture containing the acrylic monomers. In some embodiments, the polymerization reaction mixture contains about 0.01-5%, about 0.01-0.5%, about 0.5-1%, about 1-2%, about 2-5%, about 0.1-0.3%, or about 0.2% of a radical initiator, such as AIBN, by weight.

### Crosslinker

Some embodiments include a crosslinker. In some examples, an isocyanate or a polyisocyanate may be used as a crosslinker. A polyisocyanate comprises a compound which includes at least two isocyanate groups. In some embodiments, the polyisocyanate may be a diisocyanate. In some examples, the diisocyanate may be an aliphatic diisocyanate. In some embodiments, the crosslinker may be about 0.01 wt% to about 5 wt%, about 0.01-0.05 wt%, about 0.05-0.1 wt%, about 0.1-0.5 wt%, 0.5-1 wt%, about 1-2 wt%, about 2-3 wt%, about 3-4 wt%, about 4-5 wt%, or about 0.15 wt%, or any value in a range bounded by any of these values.

In some embodiments, the polyisocyanate may be a triisocyanate. In some embodiments, xylene diisocyanate (XDI) may be of particular interest. In some examples, suitable diisocyanates include, but are not limited to, xylene diisocyanate (XDI), methylenediphenyl diisocyanate (MDI),toluene-2,4-diisocyanate (TDI), hexamethylene diisocyanate (HDI),polymeric diphenylmethane diisocyanate (PMDI), isophorone diisocyanate(IPDI), methylene-4,4-bis(cyclohexyl)diisocyanate (H12MDI), or mixtures thereof. Although both aliphatic and aromatic polyisocyanates may be employed in as the crosslinker, in some embodiments the polyisocyanate may be an aliphatic polyisocyanate. Thus, in an embodiment of particular interest, the polyisocyanate is an aliphatic diisocyanate. Among aliphatic diisocyanates of particular interest are isophorone diisocyanate, hexamethylene diisocyanate, or mixtures thereof. Suitable polyisocyanates are, for example, commercially available under the trademark name Takenate D-110N from Mitsui Chemicals America, Inc. (San Jose, CA, US). The use of aliphatic isocyanates may have the advantage that the resulting isocyanate-functional polyurethane polymer is less reactive towards the organic or inorganic salt or further compounds such as polar compounds used a solvating matrix or additives. It is believed that this property of the isocyanates may provide electrically debondable reactive hot melt adhesive compositions with improved storage stability.

### Polymer Modifier

In some embodiments, in order to improve heat resistance of the electrically peelable adhesive composition, one or more polymer modifiers may be added. In some embodiments, the polymer modifier may be added to the adhesive and not polymerized with the acrylic polymer. In some embodiments, the adhesive composition may comprise a nitrogen-containing compound bearing a vinyl group, e.g., a vinyl imidazole. In some embodiments, the adhesive composition may comprise a nitrogen-containing monomer. Examples of nitrogen containing monomers include acrylamide, methacrylamide, N-vinyl pyrrolidone, N,N-dimethylacrylamide, N,N-dimethyl methacrylamide, N,N-diethylacrylamide, N,N-diethyl methacrylamide, N,N′-methylenebisacrylamide, N,N-dimethylaminopropyl acrylamide, N,N-dimethylaminopropyl methacrylamide, methylvinylpyrrolidone, vinylpyridine, vinylpiperidone, vinylpyrimidine, vinylpiperazine, vinylpyrazine, vinylpyrrole, vinyl imidazole, vinyloxazole, vinylmorpholine, N-vinylcarboxylic acid amides, and N-vinylcaprolactam, and diacetone acrylamide. In some embodiments, the nitrogen group-containing monomer may be used alone or in any combination.

### Ionic Debondable Adhesive

Some embodiments include an ionic debondable adhesive, wherein the ionic debondable adhesive may comprise an ionic liquid composition. In some embodiments, the ionic liquid composition may be used in a construct for the fabrication of a device wafer. In some embodiments, the ionic liquid composition may have increased adhesive qualities on metallic substrates in high temperature environments.

In some embodiments, the ionic liquid composition may be used for the fabrication of a device wafer. In some embodiments, the ionic liquid composition may be used for temporarily adhering at least one electro-conductive surface of a wafer carrier to at least one electro-conductive surface of a device wafer.

Some embodiments include an ionic debondable adhesive, wherein the ionic debondable adhesive has a first level of adhesion and a second level of adhesion. In some examples, the first level of adhesion is greater than the second level of adhesion. In some embodiments, the ionic debondable adhesive may comprise an ionic liquid composition. In some embodiments, the ionic liquid composition may display reduced adhesion upon the application of an electromotive force. In some embodiments, the ionic liquid composition may have a reduced Lewis acidity. In some embodiments, the ionic liquid composition may have a reduced molecular weight, e.g., less than 160 g/mole.

In some embodiments, the electrically peelable adhesive composition of the present disclosure comprising an ionic liquid may have a reduced corrosiveness upon a metallic surface.

In some embodiments, the ionic liquid composition may comprise an imidazolium cation of the following formula:

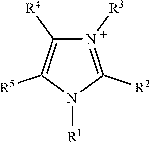

In some embodiments, at least one R⁴ and R⁵ may be independently be a hydrogen, a C₁-C₂ alkyl, a C₁-C₃ alkyl, a C₁-C₄ alkyl, a C₁-C₅ alkyl, and/or a C₁-C₆ alkyl; wherein R¹ may be a C₁-C₃ alkyl, a C₁-C₄ alkyl, a C₁-C₅ alkyl, and/or a C₁-C₆ alkyl; and/or an alkenyl, a C₁-C₃ alkoxyalkyl; wherein R² may be hydrogen, a C₁-C₃ alkyl, a C₁-C₄ alkyl, a C₁-C₅ alkyl, and/or a C₁-C₆ alkyl; and wherein R³ may be a C₁-C₃ alkyl, a C₁-C₄ alkyl, a C₁-C₅ alkyl, and/or a C₁-C₆ alkyl, and/or an alkenyl, a C₁-C₃ alkoxyalkyl; or an acetoxy C₁-C₃ alkyl, and/or a C₅-C₇ aryl.

In other embodiments R⁴ may be a C₁-C₂ alkyl and R⁵ may be a hydrogen. In some embodiments, R⁴ may be hydrogen and R⁵ may be C₁-C₂ alkyl. In other embodiments, the C₁-C₂ alkyl may be a methyl and/or ethyl group. In other embodiments, the imidazolium cation of formula 1 is less than or equal to 160 g/mole.

In some embodiments, the R¹, R², R³, R⁴ and/or R⁵ substituents and/or combinations thereof may be a hydrophilic functional group. In some embodiments, at least one of R¹, R², and/or R³ and/or combinations thereof may be hydrophilic functional group. In some embodiments, the hydrophilic functional group may comprise oxygen. In some embodiments, the oxygen containing hydrophilic functional group may comprise an ether, hydroxyl, alkoxyl and or ester group. In some embodiments, the hydrophilic functional group may comprise nitrogen, sulfur and/or phosphorous. In some embodiments, the hydrophilic functional group may comprise an amino group, a sulfhydryl group and/or a phosphate group.

In some embodiments, the R¹, R², R³, R⁴ and/or R⁵ substituents and/or combinations thereof may be hydrophobic functional group. In some embodiments, at least one of R¹, R², and/or R³ and/or combinations thereof may be hydrophobic functional group. In some embodiments, the hydrophobic functional group may comprise an optionally substituted alkyl group. In some embodiments, the optionally substituted alkyl group may comprise a methyl, ethyl, and / or propyl group. In some embodiments, the hydrophobic functional group[s] may comprise an optionally substituted aryl group. In some embodiments, the optionally substituted aryl group may comprise a phenyl and / or benzyl group.

In some embodiments, the R¹, R², R³, R⁴ and/or R⁵ substituents and/or combinations thereof may be independently substituted, wherein the cation may be asymmetrical.

In some embodiments, R¹ may be a C₁-C₃ alkyl and/or alkenyl, and/or a C₁-C₃ alkoxyalkyl. In some embodiments the C₁-C₃ alkyl may be a methyl, ethyl, n-propyl, and/or isopropyl group. In some embodiments the C₁-C₃ alkoxyalkyl may be a methyloxymethyl, ethoxymethyl, propyloxymethyl, methyloxyethyl, ethoxyethyl, propyloxyethyl, methyloxypropyl, ethoxypropyl, and/or propyloxypropyl group.

In some embodiments, R² may be a hydrogen and/or a C₁-C₃ alkyl. In some embodiments the C₁-C₃ alkyl may be a methyl, ethyl, n-propyl, and/or isopropyl group.

In some embodiments, R³ may be a C₁-C₂ alkyl, or a C₁-C₃ alkyl, a C₁-C₄ alkyl, a C₁-C₅ alkyl, a C₁-C₆ alkyl, a C₁-C₂ alkoxy, a C₁-C₃ alkoxy, a C₁-C₄ alkoxy, a C₁-C₅ alkoxy, a C₁-C₆ alkoxy, a C₁-C₂ alkoxy C₁-C₂ alkyl, a C₁-C₃ alkoxy C₁-C₂ alkyl, a C₁-C₄ alkoxy C₁-C₂ alkyl, a C₁-C₅ alkoxy C₁-C₂ alkyl, a C₁-C₆ alkoxy C₁-C₂ alkyl, a C₁-C₂ alkoxy C₁-C₃ alkyl, a C₁-C₂ alkoxy C₁-C₄ alkyl, a C₁-C₂ alkoxy C₁-C₅ alkyl, a C₁-C₂ alkoxy C₁-C₆ alkyl, a C₁-C₃ alkoxy C₁-C₃ alkyl, a C₁-C₃ alkoxy C₁-C₄ alkyl, a C₁-C₃ alkoxy C₁-C₅ alkyl, a C₁-C₃ alkoxy C₁-C₆ alkyl, a C₁-C₄ alkoxy C₁-C₂ alkyl, a C₁-C₄ alkoxy C₁-C₃ alkyl, a C₁-C₄ alkoxy C₁-C₄ alkyl, a C₁-C₄ alkoxy C₁-C₅ alkyl, a C₁-C₄ alkoxy C₁-C₆ alkyl, a C₁-C₅ alkoxy C₁-C₃ alkyl, a C₁-C₅ alkoxy C₁-C₄ alkyl, a C₁-C₅ alkoxy C₁-C₅ alkyl, a C₁-C₅ alkoxy C₁-C₆ alkyl, a C₁-C₆ alkoxy C₁-C₃ alkyl, a C₁-C₆ alkoxy C₁-C₄ alkyl, a C₁-C₆ alkoxy C₁-C₅ alkyl, a C₁-C₆ alkoxy C₁-C₆ alkyl, an acetoxy C₁-C₃ alkyl, an acetoxy C₁-C₄ alkyl, an acetoxy C₁-C₅ alkyl, an acetoxy C₁-C₆ alkyl or a C₅-C₇ aryl, an hydroxyalkyl, and/or a ω-alkyloxy-ω-oxoalkyl. In some embodiments the C₁-C₆ alkyl may be a methyl, ethyl, n-propyl, and/or isopropyl group, etc. In some embodiments the C₁-C alkoxy, may be a methoxy, ethoxy, a propoxy group, etc. In some embodiments the C₁-C₃ alkoxy C₁-C₃ alkyl may be a methyloxymethyl, ethoxymethyl, propyloxymethyl, methyloxyethyl, ethoxyethyl, propyloxyethyl, methyloxypropyl, ethoxypropyl, propyloxypropyl group, etc. In some embodiments, the acetoxy C₁-C₃ alkyl may be an acetoxymethyl, acetoxyethyl, acetoxypropyl group, etc. In some embodiments, the C₅-C₇ aryl group may be a benzyl group. In some embodiments, the hydroxyalkyl may be hydroxymethyl, 2-hydroxyethyl, 2-hydroxypropyl, 3-hydroxypropyl, 4-hydroxybutyl, etc. In some embodiments, the ω-alkyloxy-ω-oxoalkyl may be 3-methoxy-3-oxopropyl, 4-ethoxy-4-oxobutyl, etc.

In some embodiments, R¹ may be selected from hydrogen, —CH₃, —CH₂—CH₃, —CH₂—(CH₃)₂, or —CH₂—O—CH₃. In some embodiments, R² may be hydrogen, —CH₃, or —CH₂—CH₃. In some embodiments, R³ may be hydrogen, —CH₃, —CH₂—CH₃, —CH₂—(CH₃)₂, or—CH₂—O—CH₃. In some embodiments, R⁴ may be hydrogen, —CH₃, or —CH₂—CH₃. In some embodiments, R⁵ may be hydrogen, —CH₃, or —CH₂—CH₃.

In some embodiments, the imidazolium cation may be selected from:

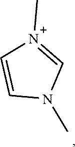

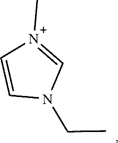

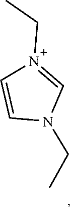

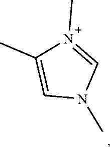

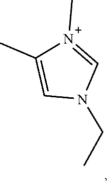

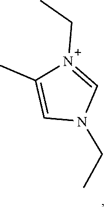

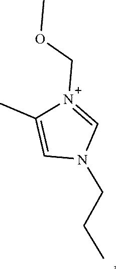

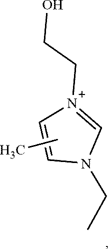

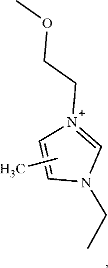

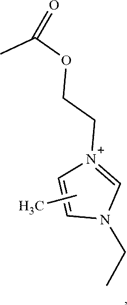

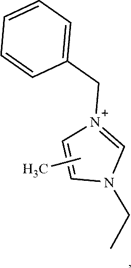

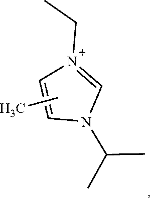

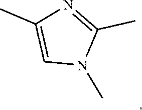

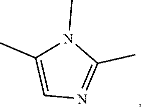

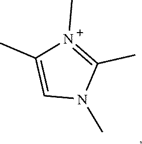

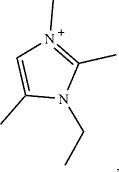

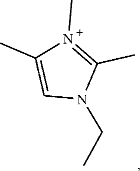

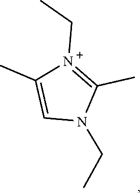

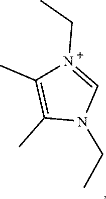

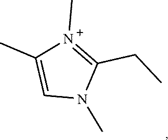

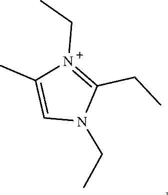

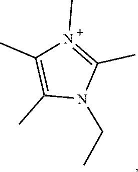

or any combination thereof.

In some embodiments, the ionic liquid composition may comprise a sulfonylsulfonic amide anion. In some embodiments, the sulfonylsulfonic amide anion may comprise a fluoroalkylsulfonylamide compound. In some embodiments, the sulfonylsulfonic amide anion may comprise a fluorosulfonylamide compound. In some embodiments, the fluorosulfonylamide compound may be of the following formula:

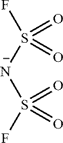

In some embodiments, the sulfonylsulfonic amide anion may comprise a trifluoromethansulfonylamide compound. The term bis(trifluoromethanesulfonyl)imide I(F₃C)SO₂)₂N]⁻refers to the chemical structure shown below:

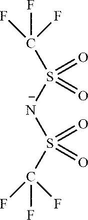 [SMILES: O=S(=O)([N-]S(=O)(=O)C(F)(F)F)C(F)(F)F]

In some embodiments, the anion may comprise an alkyl sulfonate compound. A sulfonate group has the chemical formula -SO₃⁻. Thus, an alkyl sulfonate may include alkyl groups as defined herein bearing a sulfonate group, e.g., methane sulfonate, ethanesulfonate, dodecanesulfonate, and the like.

Other embodiments include an ionic liquid composition which may further provide reduced corrosiveness upon application to metallic substrates.

Some embodiments include an ionic liquid composition temporarily adhering a first electro-conductive surface and a second electro-conductive surface together, wherein the application of electromotive force to the electro-conductive surfaces reduces the adhesive strength of the ionic liquid composition. In some embodiments, the ionic liquid composition may further comprise an imidazolium cation described above. In other embodiments, the ionic liquid composition embodiments may further comprise the aforedescribed sulfonylsulfonic amide anion. In other embodiments, the ionic liquid composition may further comprise a polymer selected from an acrylate polymer. In some embodiments the acrylic polymer material may be a (meth)acrylic material.

In some embodiments, the glass transition temperature of the polymer is below 0° C. In some embodiments, the polymer may be an acrylic polymer. In some embodiments, the acrylic polymer may contain a monomer unit derived from a C₁-C₁₄ alkyl group-containing alkyl (meth)acrylate ester. In some embodiments, the acrylic polymer may contain a monomer unit derived from a C₁-C₁₄ alkyl or alkoxy group. In some embodiments, the acrylic polymer may contain an alkyl (meth)acrylate ester, and a monomer unit derived from a polar group-containing monomer. In some embodiments, the polar group containing monomer may be a carboxyl group containing monomer. In some embodiments, the C₁-C₁₄ alkyl group containing alkyl (meth)acrylate ester is butyl(meth)acrylate.

In some embodiments, the ionic liquid composition may be reworkable.

### Method for Processing and Recovering a Processed Adhered Silicon Wafer

Some embodiments include a method for processing and recovering a processed adhered device wafer. In some embodiments, the method includes disposing the ionic debondable adhesive on the electro-conductive wafer carrier or the electro-conductive surface of the device wafer, or both. Some embodiments include adhering the ionic debondable adhesive, the electro-conductive wafer carrier, and the electro-conductive surface of the device wafer together. Some embodiments include fabricating an electronic component and/or circuit on the exposed circuit processing surface of the device wafer, connecting the construct with a voltage supply, thereby placing the electro-conductive wafer carrier, ionic debondable adhesive and the electro-conductive surface of the device wafer in electrical communication, and debonding (or delaminating) the device wafer from the wafer carrier by applying a voltage from the voltage source to the construct.

Any suitable method may be used for disposing the ionic debondable adhesives. In some embodiments, the adhesive may be applied directly as a liquid or gel. In other embodiments, the adhesive may form a film.

Other embodiments include methods for forming a film layer comprising: dissolving an ionic debondable adhesive in a solvent; forming a layer of the dissolved ionic debondable adhesive on the electro-conductive surface of the wafer carrier or on the flexible surface of the electro-conductive polymer layer. Still other embodiments include the drying of the ionic debondable adhesive solute layer to form the film layer. In some embodiments, the ionic debondable adhesive may comprise an ionic liquid composition. In some embodiments, the ionic liquid composition may comprise an imidazolium cation. In some embodiments, the imidazolium cation may be EMIM (1-ethyl-3-methylimidazolium). In some embodiments, the ionic liquid composition may further comprise a bis(sulfonyl)imide anion. In still other embodiments, the ionic liquid composition may comprise the polymers described above.

Some embodiments include the formation of an adhesive film for the temporary adhering of an electro-conductive wafer carrier to an electro-conductive polymer layer. In some embodiments, the formation of the adhesive film may comprise an ionic debondable adhesive coated onto the electro-conductive surface of the wafer carrier or the flexible surface of the electro-conductive polymer layer. Other embodiments include a method of adhering the electro-conductive surface of the wafer carrier to an electro-conductive polymer layer comprising: forming a film layer comprising an ionic debondable adhesive on the electro-conductive surface of the wafer carrier or on the flexible surface of the electro-conductive polymer layer; bonding the electro-conductive wafer carrier to the electro-conductive polymer layer, wherein the ionic debondable adhesive is in physical communication with the flexible surface of the electro-conductive polymer layer and the electro-conductive surface of the wafer carrier.

### Preparation of an Electro-Conductive Surface of a Device Wafer

Some embodiments include an electro-conductive device wafer. The electro-conductive surface of a device wafer may be constructed by coating a surface of a device wafer with a conductive metal layer. The method for coating a surface of a device wafer with an electro-conductive layer is not particularly limited but may include any suitable method, for example, sputtering, platting, thermo-evaporation, physical vapor deposition (PVD), and the like.

The electro-conductive layer may comprise any electro-conductive metal. In some embodiments, the electro-conductive metal may be aluminum. The electro-conductive layer may comprise a conventional material such as a metal, mixed metal, alloy, metal oxide or mixed-metal oxide, or a conductive polymer. Examples of suitable metals include the Group 1 metals, the metals in Groups 4, 5, 6, and the Group 8-10 transition metals. In some embodiments, the electro-conductive metal may be Al, Ag, Mg, Ca, Cu, Mg/Ag, LiF/Al, CsF, CsF/Al, or alloys thereof. In some embodiments, the electro-conductive layers may have a thickness in the range of about 1 nm to about 1000 µm.

In some embodiments, the ionic liquid composition may have a reduced corrosive effect upon the electro-conductive layers. Suitable means to assess the corrosive effect of the ionic liquid composition upon the electro-conductive materials may be the procedures described in ASTM G69-12 (Standard Test Method for Measurement of Corrosion Potentials of Aluminum Alloys). Suitable alternative means to assess the corrosive effect of the ionic liquid composition upon the electro-conductive materials may be achieved by visually examining the interface between the ionic liquid composition and the substrate for any indication of corrosive degradation of the substrate and/or dissolution of the metal in the selectively adherent composition and/or pitting of the substrate.

Selective electro-conductive adhesive layers comprising the compounds disclosed herein may be fabricated using any suitable technique, as informed by the guidance provided herein.

### Embodiments

Embodiment 1. An electrically peelable adhesive composition comprising:
An acrylic polymer, wherein the acrylic polymer comprises at least one polar monomer group comprising a hydroxyl group and at least one polar monomer comprising an alkoxy group;
At least two ionic liquids, wherein the at least two ionic liquids comprise at least one cation and at least a first anion and a second anion, wherein the at least first anion is an alkyl sulfonate and the second anion is a sulfonyl amide, and wherein the at least two ionic liquids are greater than 11.0 wt% [15.5 parts by mass] of the polymer; and 0.1 to 10 wt% vinyl compound comprising nitrogen.

Embodiment 2.The electrically peelable adhesive composition of embodiment 1, wherein the acrylic polymer comprises 2-methoxyethyl acrylate.

Embodiment 3.The electrically peelable adhesive composition of embodiment 1, wherein the 2-methoxyethyl acrylate comprises 75 to 99 wt% of the acrylic polymer.

Embodiment 4.The electrically peelable adhesive composition of embodiment 1, wherein the acrylic polymer comprises 4-hydroxybutyl acrylate.

Embodiment 5.The electrically peelable adhesive composition of embodiment 1, wherein the 4-hydroxybutyl acrylate comprises 1.0 to 25 wt% of the acrylic polymer.

Embodiment 6.The electrically peelable adhesive composition of embodiment 1, wherein the alkyl sulfonate is methane sulfonate.

Embodiment 7.The electrically peelable adhesive composition of embodiment 1, wherein the vinyl monomer comprising nitrogen is vinyl imidazole.

Embodiment 8.An electrically peelable adhesive composition comprising:
An acrylic polymer comprising at least one polar copolymer unit comprising a hydroxyl group, at least one polar copolymer unit comprising an alkoxy group and pendant vinyl unit, the pendant vinyl groups comprising nitrogen;
At least two ionic liquids, wherein the at least two ionic liquids comprise at least one cation and at least one alkyl sulfonate anion and a second anion, and wherein the at least two ionic liquids are greater than 11.0 wt% [15.5 parts by mass] of the polymer.

Embodiment 8b. The adhesive composition of embodiment 2, wherein the alkyl sulfonate anion comprises methane sulfonate.

Embodiment 9.The adhesive composition of embodiment 8, wherein the pendant vinyl group comprising nitrogen is a vinyl imidazole.

Embodiment 10. The adhesive composition of embodiment 8, wherein the acrylic polymer is cross-linked with a diisocyanate crosslinker.

Embodiment 11. A method for making an electrically peelable adhesive composition comprising:
providing an acrylic polymer comprising a hydroxy containing monomer and an alkoxy containing monomer;
mixing the polymer with 0.01 to 25.0 wt% ionic cation and anion mixture, wherein the anion comprises an alkyl sulfonate and a nitrogen containing vinyl composition; and
cross linking with a diisocyanate crosslinking agent.

Embodiment 12. The method of embodiment 11, wherein acrylic polymer comprises 1 wt% to 40 wt% alkoxy monomer.

Embodiment 13. The method of embodiment 11, wherein acrylic polymer comprises 60 wt% to 99 wt% hydroxy monomer.

Embodiment 14. The method of embodiment 11, wherein the alkyl sulfonate anion comprises a methanesulfonate anion.

Embodiment 15. The method of embodiment 11, wherein nitrogen containing vinyl composition contains vinyl imidazole.

### EXAMPLES

It has been discovered that embodiments of ionic debondable adhesive and elements described herein reduce the deterioration and/or corrosion of the conductive metal layers described herein. These benefits are further shown by the following examples, which are intended to be illustrative of the embodiments of the disclosure, but are not intended to limit the scope or underlying principles in any way.

### Preparation of Polymer Solution

95 wt% 2-methoxy ethyl acrylate (142.5 g), 5 wt% parts 4-hydroxybutyl acrylate (4HBA) (7.5 g) 75 wt% mass parts ethyl acetate (440 g) were introduced into a stirring flask attached to a condenser that was equipped with a nitrogen gas inlet. The mixture was stirred at room temperature while introducing the nitrogen gas, for about 1 hour to remove oxygen from the reaction system. 0.2 mass parts azobisisobutyronitrile (AIBN) were added, which increased the temperature of the resulting mixture to about 65±2° C., and mixed/stirred for about 5-6 hours for polymerization. After stopping the reaction, an acrylic polymer-containing solution resulted, having a solid content of about 25%. The apparent molecular weight of the polymer solution (P1) was determined to be about 800,000, with a Tg (glass transition temperature) of about -50° C.

### Preparation of Polymer Additive Mixture

0.375 g (15 wt%) of AS-210 ionic liquid (1-ethyl-3-methylimidazolium bis(trifluoromethylsulfonyl)imide (EMIM-TFSI)) was added to a 20 mL vial. 0.125 g of 10% and 1-ethyl-3-methyl imidazolium (cation) and methanesulfonate (anion) ionic liquid (EMIM-MeSo3) in (CAN) and 0.125 gm vinyl imidazole were added to the AS-210 ionic liquid. The mixture was vortexed on a mixer set on medium for greater than about 2 minutes. 10 gm of the polymer solution described in Example 1 was added with additional ethyl acetate to viscosity adjustment, and vortexed on the above identified mixture for greater than 3 minutes. 0.075 g 5% Takenate DN-110 in ethyl acetate was added and the resultant mixture was vortexed on the above identified mixer and settings for greater than 5 minutes. The mixture was placed in a 4° C. environment for 2-3 hours.

### Preparation of Adhesive Sheet

An adhesive sheet was prepared by mixing the polymer solution described above to obtain in electrically de-bondable adhesive compositions. The prepared compositions were coated/deposited upon a surface treated PET separator (release liner) (MR38, made by Mitsubishi Plastics, Japan), forming an adhesive composite layer at a thickness of about 20 µm to about 150 µm (microns). The coated film was then heat dried at 130° C. for about 3 minutes to obtain an adhesive layer/sheet have a thickness about 10 µm to about 50 µm.A PET release liner was aligned with the coated film and then aged at 50° C. for about 24 hours to obtain an adhesive layer/sheet having a thickness of about 10 µm to about 50 µm.

Asymmetric de-bonding adhesive structure is obtained if a metalized polyimide is attached to the first prepared adhesive with the metal layer either in or out depending on the application requirements.

Symmetric de-bonding adhesive structure is also obtained if the adhesive is coated on to the metalized polyimide with the metal layer in or out depending on the application requirements.

### Preparation of Metalized Device Wafer

A metalized wafer may be constructed by the application of a metal substrate onto the surface of device wafer. The metallization of the device wafer may be performed by any suitable method, and below are two illustrative examples. The first example of metalizing a device wafer surface involves sputtering an aluminum coating (or other metal coatings like silver, nickel, etc.) on the device wafer. The thickness of the metal surface may be from about 10 nm to several microns. A person knowledgeable in the art would understand the procedures for commercial sputtering systems like radio frequency (RF) and magnetron/plasma vapor deposition (PVD) sputtering. A second example of metalizing a device wafer surface involves attaching a metalized film to the device wafer with an adhesive intermediary like 5000NS (Nitto Denko Corporation, Japan). This method involves a piece of double sided tape, such as, 5000NS, which is applied onto one surface of a device wafer. Next, an aluminum polyimide film (PIT1N-ALUM | 1 mil Polyimide [Kapton] Film with Sputtered Aluminized Coating) (CAPLINQ, Ottawa, Ontario, CA) is adhered to such that the metalized surface of the aluminum - polyimide film is distal to the device wafer, creating an exposed aluminum (metalized) surface. These examples for preparing a metalized surface on a device wafer are intended to be illustrative of the embodiments of the disclosure and are not intended in any way to limit the scope or underlying principles of the embodiments disclosed herein.

### Adhesion Test

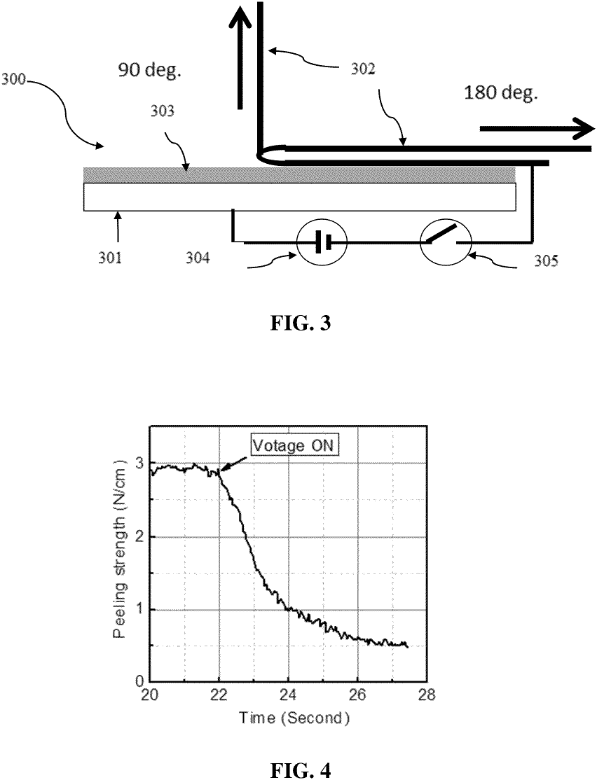

The testing for adhesion was done in the manner as described in JP 2015-228951 and/or JP 2015-204998 and shown in FIG. 3.

As shown in FIG. 3, the adhesive material 303, e.g., the adhesive sheet described above, was coated upon a conductive substrate 301 of 25 mm wide and 100 mm long and laminated upon another flexible conductive layer 302 (such as aluminum foil and/or metalized plastic film such as PET), which is 10 mm to 25 mm wide and 100 mm longer than 301 and by the application of rolling pressure, by 2 kg roller and roll press.

The bonding/de-bonding tester used was an Autograph AGS-X model, Shimadzu North America, Carlsbad, CA, USA. The conductive substrate 301, was fixed onto the lower clamp and then electrically connected to the positive pole of a power supply 304 (Protek DC Power Supply 3006B). The top layer 302, in FIG. 3, was fixed to the upper clamp which is connected with the negative pole of the same DC power supply. The power supply had an output range from 0 to 100 VDC. The moving/peeling speed was set at 300 mm/min.

In a dynamic test, the voltage was applied a few seconds after the peeling or separation starts and the time and peeling strength readings from the force gauge are recorded by the data acquisition system (Shimadzu Autograph software, Trapezium X, Shimadzu North America, Carlsbad, CA, USA). FIG. 4 shows the 180 degree peeling strength evolution with time when a 10 VDC was applied to the adhesive material.

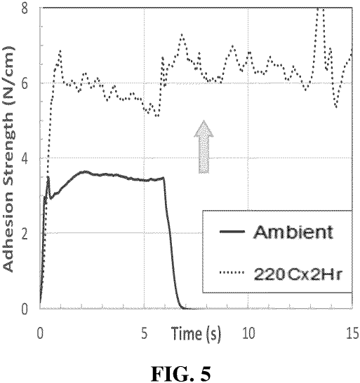

In a static de-bonding test, the sample was fixed on to the tester and connected to the power supply in the same way. The initial 180 deg. peeling was measured at the same peeling speed. Then peeling was stopped. A DC voltage (10 VDC for example) was applied for some time (10 second to 3 minutes). And then the peeling strength was measured at the same peeling speed of 300 mm/min. For the same adhesive sample from above, the initial peeling strength is 3.0 N/cm; while the residual adhesion peeling strength is about 0.5 N/cm after applying 10 VDC for 10 second, as shown in FIG. 5.

### Temporary Wafer Bonding/De-Bonding

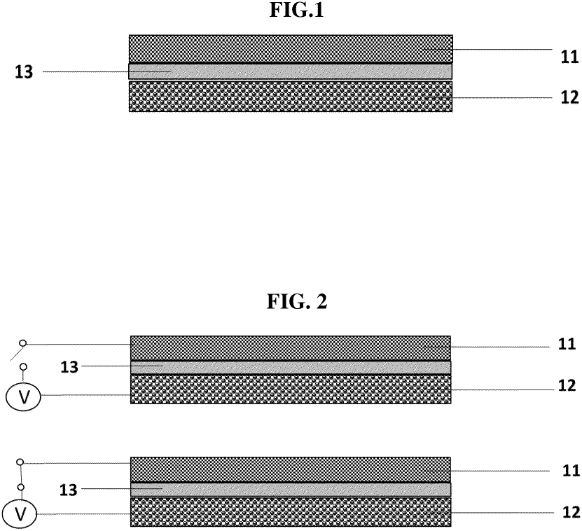

As shown in FIGS. 1 and 2, a device wafer was metalized by attaching an aluminum (Al) foil (about 15 µm) with the adhesive 5000NS. Next, the metalized device wafer, 12, was laminated to a flat electro-conductive wafer carrier plate, 11, with an ionic debondable adhesive, 13, which contained the composition, e.g., the adhesive sheet described above. Once laminated to the electro-conductive wafer carrier plate the device wafer is processed. After processing, a 10 VDC electrical field, 14, is applied between the Al plate and the Al foil. After applying the electrical field for 30 seconds, the ionic debondable adhesive strength is reduced and the device wafer may be easily separated from the electro-conductive wafer carrier with a force of only about 7 N.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

The terms “a,” “an,” “the” and similar referents used in the context of describing the present disclosure (especially in the context of the following claims) are to be construed to cover both the singular and the plural, unless otherwise indicated herein or clearly contradicted by context. All methods described herein may be performed in any suitable order unless otherwise indicated herein or otherwise clearly contradicted by context. The use of any and all examples, or exemplary language (e.g., “such as”) provided herein is intended merely to better illuminate the present disclosure and does not pose a limitation on the scope of any claim. No language in the specification should be construed as indicating any non-claimed element essential to the practice of the present disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments are described herein, including the best mode known to the inventors for carrying out the present disclosure. Of course, variations on these described embodiments will become apparent to those of ordinary skill in the art upon reading the foregoing description. The inventor expects skilled artisans to employ such variations as appropriate, and the inventors intend for the present disclosure to be practiced otherwise than specifically described herein. Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

1. An electrically peelable adhesive composition comprising:
an acrylic polymer, wherein the acrylic polymer is a product of reacting a mixture comprising a polar monomer comprising a hydroxyl group and a polar monomer comprising an alkoxy group; an ionic liquid comprising a cation, a first anion and a second anion, wherein the first anion is an alkyl sulfonate and the second anion is a sulfonylimide; and
a vinyl compound comprising nitrogen.

2. The electrically peelable adhesive composition of claim 1, wherein the acrylic polymer comprises 2-methoxyethyl acrylate.

3. The electrically peelable adhesive composition of claim 1, wherein the 2-methoxyethyl acrylate is about 60 wt% to about 99 wt% of the acrylic polymer.

4. The electrically peelable adhesive composition of claim 1, wherein the acrylic polymer comprises 4-hydroxybutyl acrylate.

5. The electrically peelable adhesive composition of claim 1, wherein the 4-hydroxybutyl acrylate is about 1 wt% to about 40 wt % of the acrylic polymer.

6. The electrically peelable adhesive composition of claim 1, wherein the vinyl compound comprising nitrogen is vinyl imidazole.

7. The electrically peelable adhesive composition of claim 1, wherein vinyl imidazole is about 0.01 wt% to about 10 wt% of the composition.

8. The electrically peelable adhesive composition of claim 1, wherein the cation of the ionic liquid is 1-ethyl-3-methylimidazolium.

9. The electrically peelable adhesive composition of claim 1, wherein the alkyl sulfonate is methane sulfonate.

10. The electrically peelable adhesive composition of claim 1, wherein the sulfonylimide is bis(trifluoromethylsulfonyl)imide.

11. The electrically peelable adhesive composition of claim 1, wherein the ionic liquid is about 10-25 wt% of the total weight of the composition.

12. The electrically peelable adhesive composition of claim 1, wherein the acrylic polymer is crosslinked with a diisocyanate crosslinker.

13. The electrically peelable adhesive composition of claim 12, wherein the crosslinker is xylene diisocyanate.

14. The electrically peelable adhesive composition of claim 12 wherein the crosslinker is about 0.01 wt% to about 5 wt% of the total weight of the composition.

15. A method for making an electrically peelable adhesive composition comprising:
crosslinking an adhesive precursor mixture with a diisocyanate crosslinking agent;
wherein the adhesive precursor mixture comprises an acrylic polymer, an ionic liquid, and a vinyl compound comprising nitrogen;
wherein the acrylic polymer is a reaction product of a polymerization mixture comprising an acrylic polymer comprising a hydroxy containing monomer and an alkoxy containing monomer; and
wherein the ionic liquid comprises a cation and one or more anions, wherein at least one anion comprises an alkyl sulfonate.

16. The method of claim 15, wherein acrylic polymer comprises 1 wt% to 40 wt% of a hydroxyl group monomer.

17. The method of claim 15, wherein acrylic polymer comprises 60 wt% to 99 wt% of an alkoxy group monomer.

18. The method of claim 15, wherein the alkyl sulfonate anion comprises a methanesulfonate anion.

19. The method of claim 15, wherein the ionic liquid further comprises a bis(trifluoromethylsulfonyl)imide anion.

20. The method of claim 15, wherein the vinyl compound comprising nitrogen comprises vinyl imidazole.
